(19) United States
(12) Patent Application Publication
(10) Pub. No.: US 2009/0295950 A1
(43) Pub. Date: Dec. 3, 2009

(54) IMAGING DEVICE

(75) Inventor: Nobuaki Abe, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/472,614

(22) Filed: May 27, 2009

(30) Foreign Application Priority Data
May 29, 2008 (JP) 2008-141571

(51) Int. Cl. H04N 9/77

(52) U.S. Cl. 348/241; 348/E09.035

(57) ABSTRACT

An imaging device has an image sensor with a mosaic color filter array comprising at least four color elements. The color elements are arrayed such that each color element opposite a pixel in the image sensor. The imaging device also has a color-transform processor that generates at least one color-transform signal in each pixel while interpolating missing color signals on the basis of color signals from surrounding pixels; and a color-interpolation processor that generates at least one color-transform signal that does not correspond to an opposing color element in each pixel on the basis of color-transform signals, which are generated over surrounding pixels and correspond to opposing color elements of that surrounding pixel respectively. The color filter array is configured such that al least two color elements that have a correlation with each other with respect to spectrum transmittance characteristics are arrayed alternately in diagonal direction of pixel array.

### BACKGROUND OF THE INVENTION

1. Field of the Invention

The present invention relates to an imaging device that generates a color image on the basis of image-pixel signals read from an image sensor such as a CCD. In particular, it relates to a color interpolation process performed when using a single imaging sensor which employs a color filter array.

2. Description of the Related Art

In a digital camera, an image sensor with an on-chip color filter array is generally used. For example, a Bayer-type mosaic color filter, composed of color elements R, G, and B, is provided in an image sensor. Each pixel in the image sensor opposes one color element and receives light of a wavelength corresponding to the opposing color element.

Since each pixel has only one color signal component corresponding to the opposing color element, a color interpolation process (called “demosaicing”) is carried out, in which color information which is missing in a target pixel is obtained from color signals generated by adjacent pixels.

As for color interpolation, various interpolation methods, such as one that calculates an average from the color signals of neighboring pixels, to one that uses a pixel adjacent to a target pixel which is relatively strongly correlated, etc., have been proposed. These interpolation processes aim to decrease the occurrence of false color or to enhance the resolution of an image, in other words, the sharpness of an image.

Generally, there is a trade-off between the occurrence of false color and the sharpness of an image. In the case of the average-calculating method, although “false color” is avoided, contrast and resolution in an image decrease since a low-pass filter function acts. On the other hand, the method using a pixel-wise, relatively strong correction (and particularly, using pixels which are not next to, but closest to the target pixel), enhances contrast and resolution in an image, however, false color, may still occur.

### SUMMARY OF THE INVENTION

An object of the present invention is to provide an imaging device, and an apparatus/method for interpolating color signals that are capable of enhancing resolution in an image and preventing the occurrence of false color.

An imaging device according to the present invention has an image sensor with a mosaic color filter array comprising at least four color elements. The color elements are arrayed such that each color element opposes a pixel in the image sensor.

The imaging device also has a color-transform processor that generates at least one color transform signal in each pixel while interpolating missing color signals on the basis of color signals from surrounding pixels; and a color-interpolation processor that generates at least one color-transform signal that does not correspond to an opposing color element in each pixel, on the basis of color-transform signals which are generated over surrounding pixels and which respectively correspond to opposing color elements of that surrounding pixel. Note that, herein, an “adjacent pixel” refers to any neighboring pixels, (i.e., pixels next to a target pixel and any pixels close to the target pixel, but not next to the target pixel, also, a “surrounding pixel” includes, herein, neighboring pixels and those adjacent, as well as pixels other than the adjacent pixels.

In the present invention, the color filter array is configured such that at least two color elements, which are correlated with respect to spectrum transmittance characteristics, are arrayed alternately in a diagonal direction of the pixel array. In particular, at least two color elements have a correlation with each other within wavelengths corresponding to the distributions of the luminosity factor, i.e, the luminosity curve.

### BRIEF DESCRIPTION OF THE DRAWINGS

The present invention will be better understood from the description of the preferred embodiments of the invention set forth below together with the accompanying drawings, in which:

FIG. 1 is a block diagram of a digital camera according to a first embodiment;

FIGS. 2A and 2B partially illustrate a color filter array and a pixel array;

FIG. 3 illustrates spectrum transmittance characteristics of the color filter array;

FIG. 4 is a flowchart of a series of image-signal processes used to generate the color-transform signals;

FIG. 5 illustrates color signals read from the CCD;

FIG. 6 illustrates color-transform signals corresponding to 5×5 pixel array;

FIG. 7 illustrates color-transform signals used for interpolating color-transform signals of “G” with respect to a pixel;

FIG. 8 illustrates color-transform signals used for interpolating color-transform signals of “B” with respect to a pixel;

FIG. 9 shows a graph representing the frequency of false color when a CZP chart is used as a subject;

FIG. 10 shows a graph of resolution performance represented by a wedge chart;

FIG. 11 is a color filter array that is a variation of the color filter array according to the first embodiment;

FIG. 12 is a block diagram of a digital camera according to the second embodiment;

FIG. 13 is a flowchart of a series of image-signal processes used to generate the color-transform signals;

FIG. 14 illustrates color-transform signals corresponding to 5×5 pixel array;

FIG. 15 is a color filter array used in a digital camera according to the third embodiment.

FIG. 16 illustrates spectrum transmittance characteristics of the color filter;

FIG. 17 illustrates color signals generated in the 4×8 pixel array;

FIG. 18 illustrates color-transform signals in the 4×8 pixel array;

FIG. 19 illustrates a color filter array that is a variation of the third embodiment;

FIG. 20 is a color filter array used in a digital camera according to the fourth embodiment;

FIGS. 21A and 21B illustrate color signals and color-transform signals in a 4×6 pixel array; and

FIG. 22 illustrates a color filter array that is a variation of the color filter according to the fourth embodiment.

### DESCRIPTION OF THE PREFERRED EMBODIMENTS

Hereinafter, the preferred embodiments of the present invention are described with reference to the attached drawings.

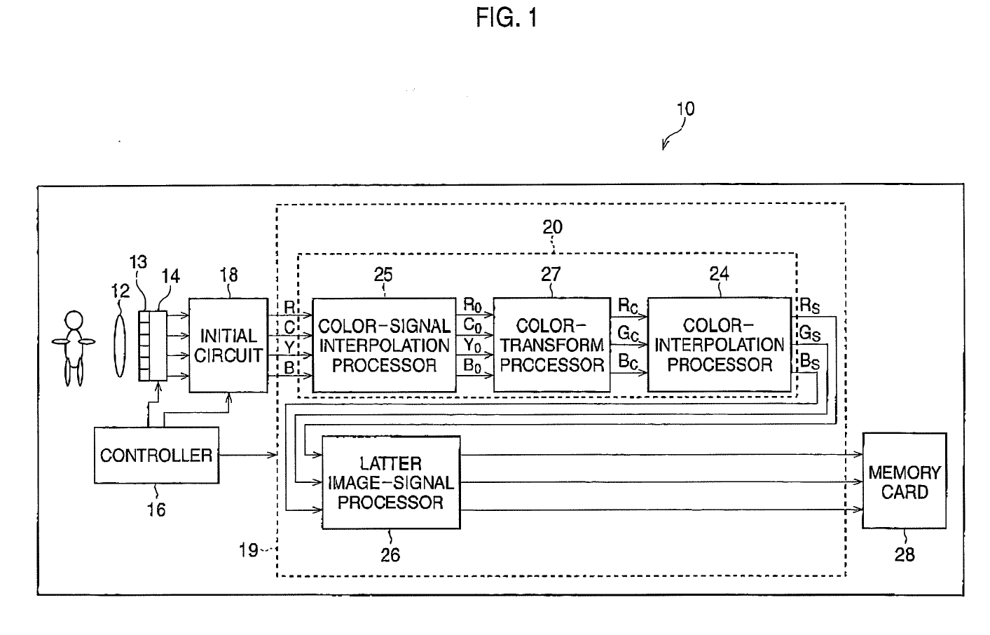

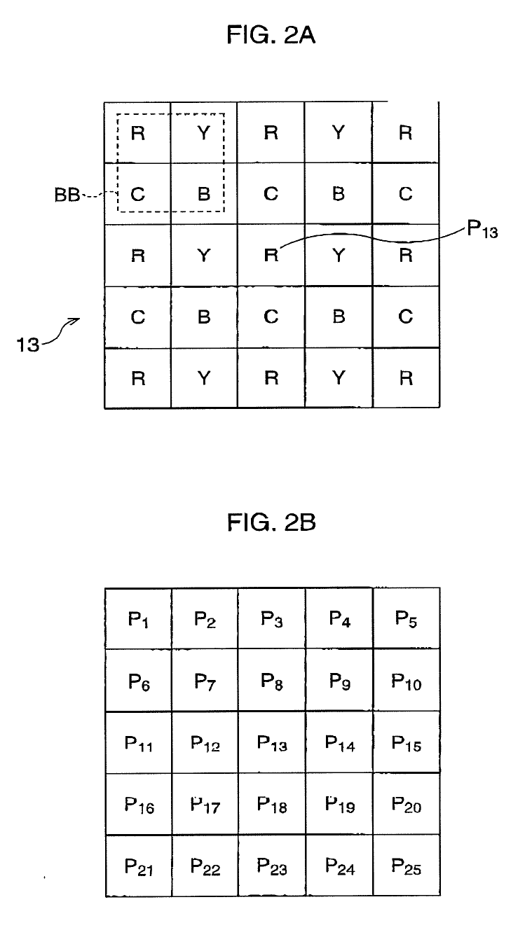

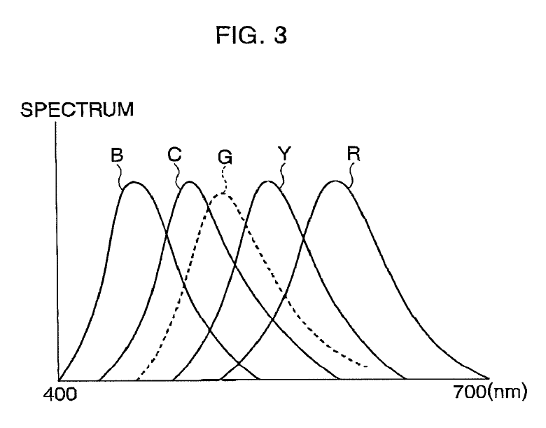

FIG. 1 is a block diagram of a digital camera according to a first embodiment. FIGS. 2A and 2B partially illustrate a color filter array and a pixel array. FIG. 3 illustrates spectrum transmittance characteristics of the color filter array.

A digital camera 10 is equipped with a photographing optical system 12 and a CCD 14, and a controller 16 including a ROM, RAM, and CPU, which carry out a photographing process by controlling an action of the camera 10. When a release button (not shown) is operated, a photographing action is carried out as explained below.

Light reflected off a subject passes through the photographing optical system 12 and a shutter (not shown) and finally reaches a CCD 14 such that an object image is formed on a light-receiving surface of the CCD 14. In this embodiment, the imaging method using a single imaging device is applied, and on-chip color filter 13 is also provided in the CCD 14.

As shown in FIG. 2, the color filter array 13 is a mosaic filter array of R, Y, C, and B color elements, in which four color elements “R, Y, C and B” are arrayed alternately. Also, the color filer array 13 is a standard Bayesian filer composed of a plurality of blocks BB having of R, C, Y, and B elements, which are next to each other. The R and Y elements are arrayed alternately in odd lines, while the B and C elements are arrayed alternately in even lines. Also, the R and B elements are arrayed alternately in one diagonal direction, and the Y and C elements are arrayed alternately in the other diagonal direction. Each pixel in the CCD 14 is opposite one of the four color elements. In FIG. 2B, there is a 5×5 pixel array Pⱼ (1≦j≦25), which is a part of the CCD 14 and also opposite the color filter array shown in FIG. 2A, as shown. For example, a pixel P₁₃ is opposite a color element “R”. And also, pixels P₈, P₁₂, P₁₄, and P₁₈, which are next to pixel P₁₀ in horizontal and vertical lines are opposite color elements “C” and “Y”; and pixels P₇, P₉, P₁₇, and P₁₉, which are next to the pixel P₁₉ in a diagonal lines are opposite a color element “B”.

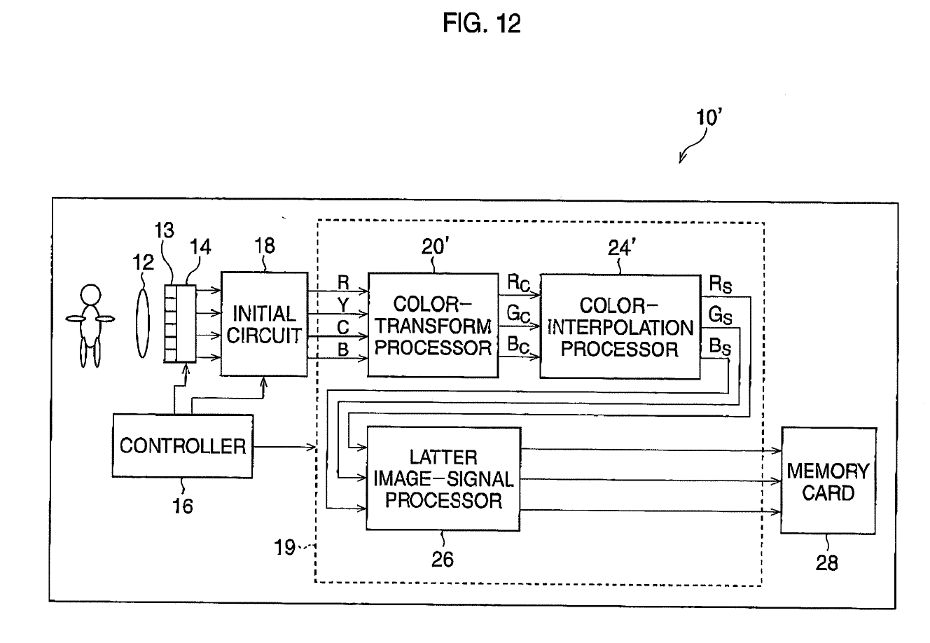

As shown in FIG. 3, spectrums of color elements are distributed at approximately equal intervals (see FIG. 12). The color element “C” has a spectral distribution in which a peak occurs approximately at the midpoint between a peak of the color element “G” and a peak of the color element “B”. On the other hand, the color element “Y” has a spectral distribution in which a peak occurs approximately at the midpoint between a peak of the color element “R” and a peak of the color element “G”.

In the CCD 14, analog image-pixel signals based on the color filter array 13 are generated, and one frame's worth of image-pixel signals (i.e., RAW data) are read from the CCD 14 on the basis of driving signals fed from the controller 16. The series of image-pixel signals is converted from the analog signals to digital signals in an initial circuit 18, and is transmitted to a color-transform processor 20, provided in a chip-type image-signal processing circuit 19, built as a DSP (Digital Signal Processor).

The color interpolation processor 20 has a color-signal interpolation processor 25 and a color-transform processor 27. In the color-signal interpolation processor 25, an interpolation process, which interpolates missing color information in each pixel, is carried out. Namely, image-pixel signals other than an opposite color element are interpolated (hereinafter, image-pixel signals are called “color signals”). Herein, color signals generated by six pixels, which are next to a target pixel in horizontal, vertical, and diagonal lines, are used in the interpolation process.

Thus, a series of color signals “Ro, Co, Yo, and Bo” are generated for each pixel by the interpolation process. In the case of the pixel P₁₃, the color signals “Bo”, “Co” and “Yo” are generated by the interpolation process, whereas the color signal “Ro” corresponds to the image-pixel signal generated on the CCD 14. The series of color signals Ro, Co, Yo, and Bo, is transmitted to the color-transform processor 27.

The series of color signals Ro, Yo, Co, and Bo are temporarily stored in a memory (not shown) provided in the color-transform processor 27, and subjected to a color-transform process (i.e., a matrix operation). Thus, a series of color-transform signals Rc, Gc, and Bc, which are color-adjusted in accordance with a color space, are generated in each pixel. The color-transform signals Rc, Gc, and Bc, obtained in each pixel, are transmitted to the color interpolation processor 24, and are temporarily stored in a memory in the color-interpolation processor 24. Then, (as described later), the series of color-transform signals, Rc, Gc, and Bc, are subjected to a color interpolation process. Consequently, a series of modified color-transform signals Rs, Gs, and Bs, are output to a latter image-signal processor 26.

In that latter image-signal processor 26, the series of color-transform signals Rs, Gs and Bs are subjected to various processes, such as a white balance adjustment process gamma correction, edge enhancement, etc. Thus, color image data is generated and stored in a memory card 28.

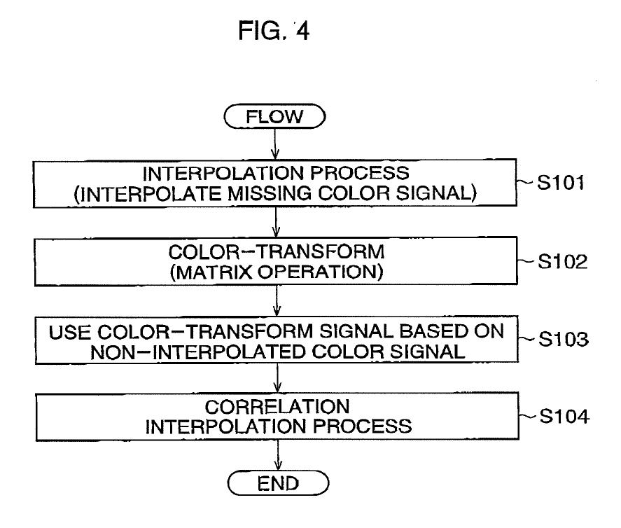

FIG. 4 is a flowchart of a series of image-signal processes used to generate the color-transform signals. The series of processes, namely, the color-signal interpolation process, the color-transform process, and the interpolation process, are explained below, in detail.

In the color-signal interpolation process, an interpolation process using neighboring pixels, is carried out (hereinafter, called a “proximity interpolation process). Specifically, an average of color signals generated on neighboring pixels is calculated to generate color signals that are missing in a target pixel (S101). For example, in the case of a target pixel opposite a color element “R”, missing color signals corresponding to a “C” and “Y” elements are interpolated by calculating an average of color signals corresponding to “C” and “Y” generated over four pixels, those next to the target pixel in horizontal and vertical directions.

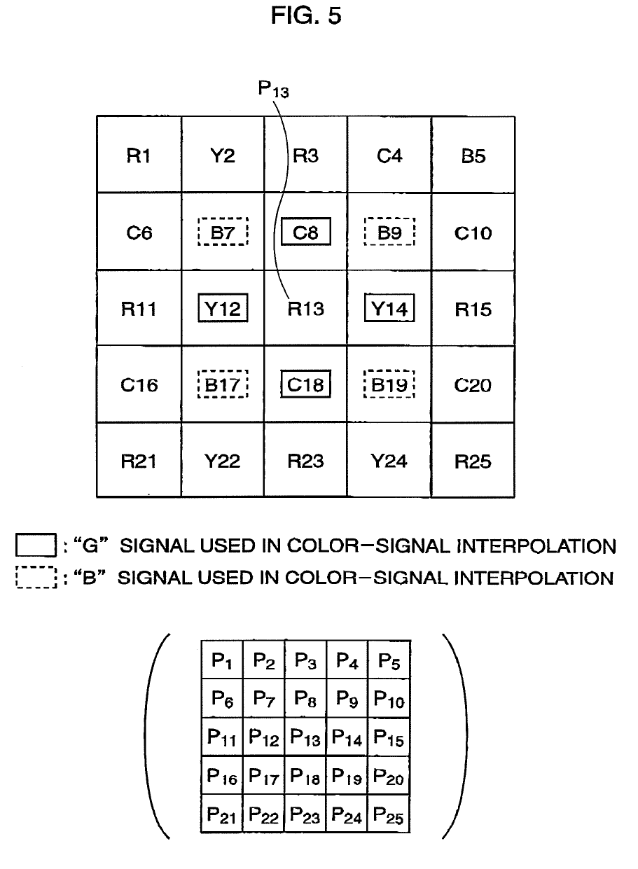

FIG. 5 illustrates color signals read from the CCD 14. Each color signal is designated by the number matching its opposite pixel. In the case of pixel P₁₃, a series of color signals R13, Y13, C13, and B13 are calculated using the following formulas:

R13=R13

Y13=(Y12+Y14)/2

C13=(C8+C18)/2

B13=(B7+B9+B17+B19)/4 (1)

The color signal of the pixel P₁₃, which is read from the CCD 14, is directly used as a color signal R13. On the other hand, the color signal C13 is obtained by calculating an average of the color signals “C8” and “C18” (generated on pixels P₈ and P₁₈, which are next to the pixel P₁₃ in vertical line). Also, the color signal Y13 is obtained by calculating an average of the color signals “C12” and “C14” (generated on pixels P₁₂ and P₁₄, which are next to the pixel P₁₃ in horizontal line). In addition, the color signal B13 is obtained by calculating an average of color pixel signals “B7, B9, B17, and B19” corresponding to pixels P₇, P₉, P₁₇, and P₁₉ (next to the pixel P₁₃ in the diagonal lines). The color signals “R13”, “Y13”, “C13”, and “B13” obtained by the proximity interpolation process are output from the color-signal interpolation processor 25.

On the other hand, when a color element opposite a target pixel is “C” or “Y” element, a missing color signal “R” is obtained by calculating an average of the color signals (generated on pixels which are next to the target pixel in vertical line or horizontal line). Also, a missing color signal “B” is obtained by calculating on average of the color signals (generated on pixels which are next to the target pixel in vertical or horizontal line). Furthermore, in the case of a pixel opposite a “B” element, a missing color signal corresponding to “C” is interpolated by calculating an average of color signals generated over two pixels, which are next to the target pixel in horizontal direction, and a missing color signal corresponding to “Y” is interpolated by calculating an average of color signals generated over two pixels, which are next to the target pixel in vertical direction. Then, a missing color signal corresponding to “R” is interpolated by calculating an average of color signals generated four pixels, which are next to the target pixel in diagonal directions. The interpolated color signals and color signals directly read from the CCD 14 are output as a series of color signals “R₀, C₀, Y0, and B₀”.

The color signals “Ro, Co, Yo, and Bo” in each pixel are subjected to the matrix operation, as shown in the following formula (S102). Herein, in accordance with the sRGB color space, a color-transform process using a 4×3 matrix is carried out:

$$( \begin{matrix}Rc \\ Gc \\ Bc\end{matrix} ) = ( \begin{matrix}1.09 & 0.23 & - 0.36 & 0.04 \\ - 0.61 & 1.17 & 0.78 & - 0.33 \\ 0.11 & - 0.21 & - 0.21 & 1.32\end{matrix} ) ( \begin{matrix}{R}_{0} \\ {Y}_{0} \\ {C}_{0} \\ {B}_{0}\end{matrix} ) \qquad ( 2 )$$

After the color-transform process is carried out, the color interpolation process is carried out (S103 and S104). In the color interpolation process, a color-transform signal generated by the color signal read out from the CCD 14 (i.e., the un-interpolated color signal) is directly utilized. On the other hand, color-transform signals based on interpolated color signals are not utilized, out rather replaced with values based on the color-transform signal (the interpolation color-transform signal), generated by the color interpolation process. The color interpolation process is explained below.

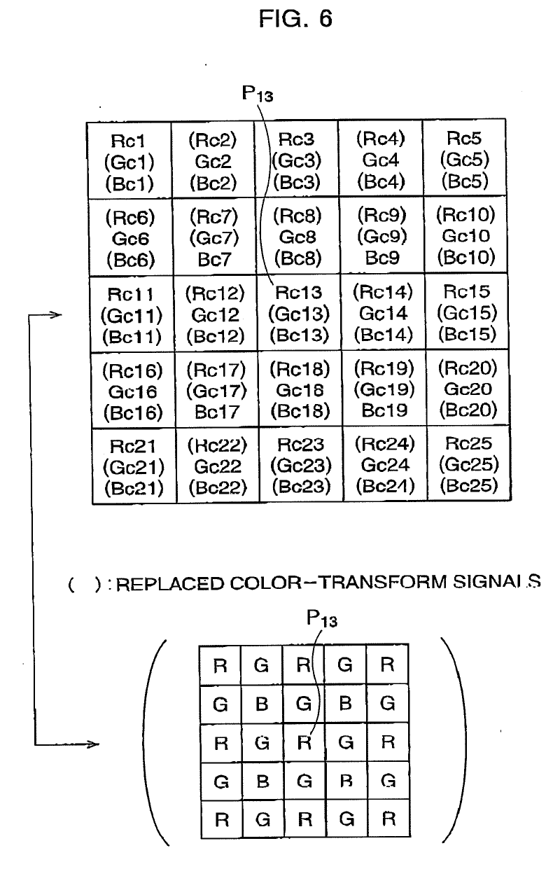

FIG. 6 illustrates color-transform signals corresponding to 5×5 pixel array. Four color signals “RO”, “Co”, “Yo”, and “Bo”, corresponding to “R”, “C”, “Y” and “B”, are generated in each pixel by the color-signal interpolation process using the formula (2). Then, the color signals “R0”, “Co”, “Yo”, and “Bo” are converted to color-transform signals by the matrix operation using the formula (2).

In the case of a pixel opposite the color element “R” (for example, P₁₃), a color-transform signal Rc is based on a color signal Ro read from the CCD 14. On the other hand, other color-transform signals Gc and Bc are obtained by transforming interpolated color signals Go and Bo. The same goes for pixels opposite “G” and “B” color elements. Namely, two color-transform signal values are based on interpolated color signals.

In the color interpolation process, color transform-signals based on the interpolated color signals are discarded. In their place, color-transform signals based on color signals read from the CCD 14 are newly generated and utilized as color-transform signals. Also, the second interpolation process carries out an interpolation process that utilizes a color-transform signal of a pixel having a relatively strong correlation to a target pixel (hereinafter, this interpolation process is called, “correlation interpolation process”).

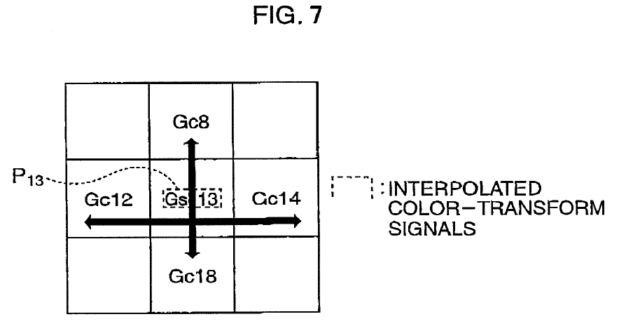

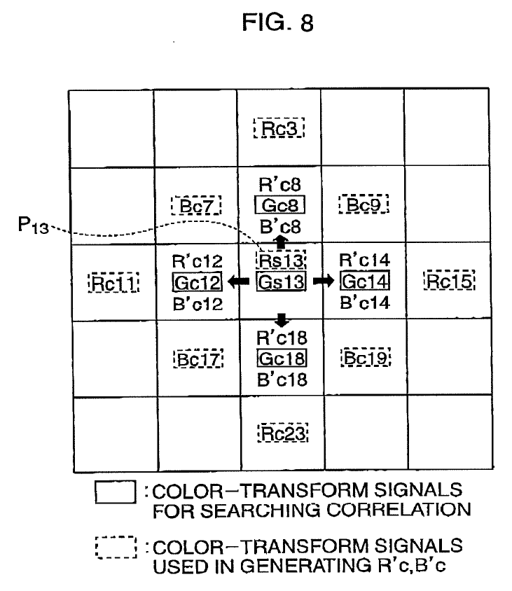

FIG. 7 illustrates color-transform signals used for interpolating color-transform signals of “G” with respect to a pixel P₁₃. FIG. 8 illustrates color-transform signals used for interpolating color-transform signals of “B” with respect to a pixel P₁₃. The correlation interpolation process is concretely explained below.

In the case of the pixel P₁₃, the color-transform signal Rc13 of the pixel P₁₃ is based on the color signal (image-pixel signal) read from the CCD 14, and is obtained by the matrix operation. Thereby, a color-transform signal Rc13 is a specified signal among the color-transform signals. On the other hand, since the color-transform signals Gc13 and Bc13 are based among the interpolated color signals, the color-transform signals Gc13 and Bc13 are not used, and new color-transform signals Gs13 and Bs13 are generated by the correlation interpolation process. Specifically, the color-transform signal Gs13 is initially generated, and then the color-transform signal Bc13 is generated by utilizing the generated color-transform signal Gs13.

To calculate the color-transform signal Gs13 corresponding to the color element “G”, two directions, i.e., a vertical direction along color-transform signals Gc8 and Gc18 of the pixel P₈ and P₁₈ and a horizontal direction along color-transform signals Gc12 and Gc14 of the pixel P₁₂ and P₁₄ are compared with each other, with respect to a correlation with the target pixel P₁₃. Note the pixel P₆, P₁₂, P₁₄, and P₁₈ are next to the pixel P₁₃ in horizontal and vertical directions, and are based on the color signals read from the CCD 14. Concretely, a difference ΔGv between color transform signals Gc8 and Gc16 along the vertical direction (=|Gc8−Gc18|) and a difference ΔGh between color transform signals Gc12 and Gc14 along the horizontal direction (=|Gc12−Gc14|) are compared with each other.

Then, based on the difference ΔGv or ΔGh, the color-transform signal Gs13 is newly obtained by the following formula.

Gs13=(Gc8+Gc18)/2(ΔGv<ΔGh)

Gs13=(Gc12+Gc14)/2(ΔGv>ΔGh) (3)

When the difference ΔGv is less than the difference ΔGh (i.e., ΔGv<ΔGh), it is determined that the correlation along the vertical direction is stronger than the horizontal direction, and an average of the color-transform signals Gc8 and Gc18 along the vertical directions is defined as a color-transform signal Gs13. On the other hand, when the difference ΔGv is greater than or equal to the difference ΔGh(ΔGv≧ΔGh), (the average of the color-transform signals Gc12 and Gc14 in the vertical direction), is defined as color-transform signal Gs13.

After the color-transform signal Gs13 corresponding to the “G” element is generated, the color-transform signal Bs13 is then calculated. The pixels P₇, P₉, P₁₇, and P₁₉, corresponding to element “R” are next to the pixel P₁₃ in the diagonal directions. However, herein, the color-transform signal Rs13 is not directly calculated from the color-transform signals Bc7, Bc9, Bc17, and Bc19 of the neighboring pixels P₇, P₉, P₁₇, and P₁₉. Instead, the degree of correlation between the pixel P₁₃ and four directions, namely, the upper side pixel P₈, the lower side pixel P₁₈; the left side pixel P₁₂, and the right side pixel P₁₄; are calculated by using the color-transform signal corresponding to the “G” element whose number is more than the “R” and “B” elements. Then, the color-transform signal Bs13 is calculated on the basis of the calculated correlation and the color space representing the relationship between R, G, and B signals and color difference signals Y, Cb, and Cr.

Firstly, the differences between the color-transform signal Gs13 calculated by the formula (3) and the color-transform signals Gc8, Gc12, Gc14, and Gc18 of the four neighboring pixels P₈, P₁₂, P₁₄, and P₁₈, are obtained as shown in the following formula. ΔGvu, ΔGvb, ΔGhr, ΔGhl represent the differences regarding the upper direction, the lower direction, the rightward direction, and leftward direction, respectively.

ΔGvu=|Gc8−Gs13|

ΔGvb=|Gc18−Gs13|

ΔGhr=|Gc14−Gs13|

ΔGhl=|Gc12−Gs13| (4)

Then, the differences ΔGvu, ΔGvb, ΔGhr, and ΔGhl are compared with each other to determine which direction has the strongest correlation with the pixel P₁₃. Concretely speaking, the neighboring pixel with minimal such difference is selected from the four neighboring pixels so as to be employed in the interpolation process.

For example, when the difference ΔGhl is minimal, the color-transform signal G12 of the left side pixel P₁₂ has the strongest correlation with the color-transform signal Gc13 of pixel P₁₃, the color-trans form signal Bs13 thus being obtained by the following formula.

$$Bs 13 = Rc 13 + 1.772 * Cb - 1.402 * Cr \\ ( \begin{matrix}Cb = - 0.169 * {R}^{′} c 12 - 0.331 * Gc 12 + 0.5 * {B}^{′} c 12 \\ Cr = 0.5 * {R}^{′} c 12 - 0.419 * Gc 12 - 0.081 * {B}^{′} c 12 \\ {R}^{′} c 12 = ( Rc 11 + Rc 13 ) / 2 \\ {B}^{′} c 12 = ( Bc 7 + Bc 17 ) / 2\end{matrix} ) \qquad ( 5 )$$

The formula (5) is based on the relationship between luminance and color difference signals (Y, Cb, and Cr) and R, G, and B color signals. This relationship is obtained from the color area of the sRGB space, as well known in prior art. The color difference Cb(=(B−Y)/1.772) and Cr(=(R−Y)/1.402) of the neighboring pixel P₁₂, are also calculated, and the color-transform signal Bs13 is calculated on the basis of the color-transform signal Rs13 (=Rc13) and the color difference signals Cb and Cr.

As can be seen from formula (5), the color-transform signals Rc12 and Bc12 obtained by the first interpolation process and the color-transform process, is not utilized, rather, provisional color-transform signals R′c12 and B′c12 corresponding to the neighboring pixel P₁₂ are used. The provisional color-transform signals R′c12 are an average of the color-transform signal Rc11 corresponding to the adjacent pixel P₁₁ and the color-transform signal Rc13. On the other hand, the provisional color-transform signals B′c12 are an average of the color-transform signals Bc7 and Bc17 of the neighboring pixels P₇ and P₁₇. All of the color-transform signals, Rc11, Rc13, Bc7, and Bc17, are based on color signals directly read from the CCD 14.

When the differences ΔGvu, ΔGvb, or ΔGhr are minimal, the color-transform signals Bs13 is calculated using one of the following formulae.

$$\begin{matrix}Bs 13 = Rc 13 + 1.772 * Cb - 1.402 * Cr \\ ( \begin{matrix}Cb = - 0.169 * {R}^{′} c 14 - 0.331 * Gc 14 + 0.5 * {B}^{′} c 14 \\ Cr = 0.5 * {R}^{′} c 14 - 0.419 * Gc 14 - 0.081 * {B}^{′} c 14 \\ {R}^{′} c 14 = ( Rc 13 + Rc 15 ) / 2 \\ {B}^{′} c 14 = ( Bc 9 + Bc 19 ) / 2\end{matrix} ) & ( 6 ) \\ Bs 13 = Rc 13 + 1.772 * Cb - 1.402 * Cr \\ ( \begin{matrix}Cb = - 0.169 * {R}^{′} c 8 - 0.331 * Gc 8 + 0.5 * {B}^{′} c 8 \\ Cr = 0.5 * {R}^{′} c 8 - 0.419 * Gc 8 - 0.081 * {B}^{′} c 8 \\ {R}^{′} c 8 = ( Rc 3 + Rc 13 ) / 2 \\ {B}^{′} c 8 = ( Bc 7 + Bc 9 ) / 2\end{matrix} ) & ( 7 ) \\ Bs 13 = Rc 13 + 1.772 * Cb - 1.402 * Cr \\ ( \begin{matrix}Cb = - 0.169 * {R}^{′} c 18 - 0.331 * Gc 18 + 0.5 * {B}^{′} c 18 \\ Cr = 0.5 * {R}^{′} c 18 - 0.419 * Gc 18 -= 0.081 * {B}^{′} c 18 \\ {R}^{′} c 18 = ( Rc 13 + Rc 23 ) / 2 \\ {B}^{′} c 18 = ( Bc 17 + Bc 19 ) / 2\end{matrix} ) & ( 8 )\end{matrix}$$

FIGS. 7 and 8 show the second interpolation process on the pixel P₁₃, (corresponding to the color element “R”). Similarly, the second interpolation process on a pixel corresponding to the color element “B” (e.g. P₇) is carried out. Namely, the direction having the strongest correlation is selected from among the two directions, i.e., vertical and horizontal directions with respect to the color element “G”, and the interpolation process is carried out to obtain the color-transform signal “G”. Then, the upper, and one among the lower, left, and right side neighboring pixels, which have the strongest correlation with a target pixel, is chosen and the color-transform signal Rs is calculated on the basis of provisional color-transform signals R′c and B′c calculated for the chosen pixel and the color difference signals Cb and Cr. The series of calculations is carried out in each pixel, such that color-transform signals Rs, Gs, and Bs of the entire image may be generated.

In the color interpolation processor 24, the proximity interpolation process may be carried out instead of the correlation interpolation process. For example, in the case of the pixel P13, color-transform signals “Rs13, Gs13, and Bs13” are obtained by the following formula.

Rs13=Rc13

Gs13=(Gc8+Gc12+Gc14+Gc18)/4 (9)

Bs13=(Bc7+Bc9+Bc17|Bc19)/4

In this manner, in the present embodiment, the color filter array 13 with four color elements R, Y, C, and B are provided on the CCD 14. In the color-signal interpolation processor 25, missing color signals are interpolated in each pixel by the proximity interpolation process. In the color-transform processor 27, the matrix operation using the 4×3 matrix is carried out on the color signals R₀, G₀, Y₀, and B₀. Then, in the color-interpolation processor 24, color-transform signals based on the interpolated color signals are replaced with a newly interpolated color-transform signals.

Since the proximity interpolation process using neighboring pixels is carried out before the color-transform process, false color artifacts do not occur. Consequently, the spread or decrease of pixels having false color due to the color-transform process is prevented. On the other hand, as for the color-transform signals, the correlation interpolation process based on the original color signals read from the CCD 14 (the uninterpolated color signals) is carried out. This protects the image from the decrease in resolution such as that referred to as “zipper noise” while also preventing the occurrence of false color, such that a sharp and highly resolved image is obtained.

Since color elements C and Y corresponding to the luminosity are arrayed, color information corresponding to color “G” can be obtained so that resolution of an image is enhanced. Also, since color elements Y and C arrayed alternately in a diagonal direction, degradation of resolution is prevented and a data process speed increases.

In order to compare the interpolation process according to the present embodiment with a prior interpolation process, experimentations for confirming an occurrence of false color and resolution have been performed.

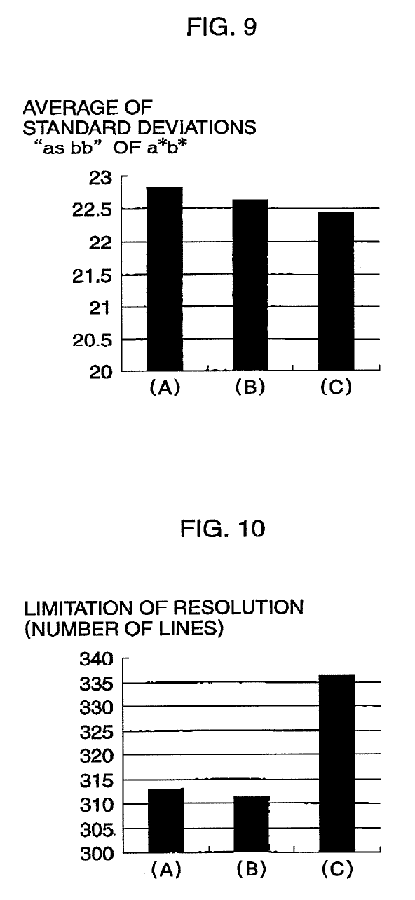

FIG. 9 shows a graph representing the frequency of false color when a CZP chart is used as a subject. Colors in the image produced when using the CZP chart are converted into the L*a*b* color space, and a histogram of color difference components a*b* is obtained. Then, an average of standard deviations “as” and “bs” taken over the color difference components a*b*, is calculated.

Herein, three image-signal processes (A) to (C) were performed, and the average of standard deviations as and Bs, and resolution limitation are derived in reference to three image-signal processes. In the process (A), only the proximity interpolation process is carried out at once. The process (C) carries out the proximity interpolation process, color-transform process, and the correlation interpolation process, as explained above. The process (B) is almost the same as the process (C) except that the proximity interpolation process is carried out.

The standard deviations “as” and “bs” of the color difference components a*b* represent the degree of unevenness in color in a chart image. When Red to Green occur frequently in an image, the standard deviation “as” becomes large, whereas the standard deviation “bs” tends to become large when Blue to Yellow colors are frequent. Herein, the degree of unevenness in color is regarded as a measure of false color. The occurrence of false color decreases in proportion to the average of the standard deviations of “as” and “bs”.

As shown in FIG. 9, the average of standard deviations according to the present embodiment is smaller than that according to the conventional processes. This indicates that the image-signal process according to the present embodiment succeeds in preventing the occurrence of false color effectively.

FIG. 10 shows a graph of resolution performance represented by a wedge chart. The wedge chart is a resolution chart based on ISO 12233, and an assessment image used is of a resolution of 480×640 pixels. In FIG. 10, the limitation in resolution is shown by the number of lines. As shown in FIG. 10, the resolution of an image resulting from the present embodiment is higher than that obtained using the conventional process.

Therefore, the image-signal process according to the present embodiment produces desirable high-resolution images.

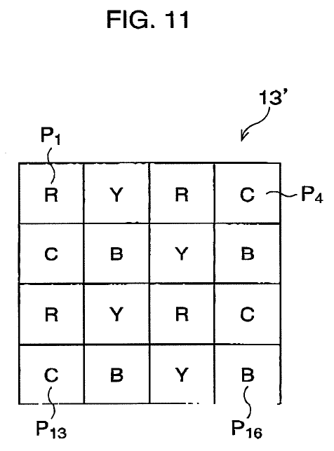

FIG. 11 is a color filter array that is a variation of the color filter array according to the first embodiment. In the color filter array 13′, color elements C are arrayed in the same vertical line. Similarly, color elements Y are arrayed in the same vertical line. Also, color elements C and Y are arrayed in horizontal line via a color element B or R. Furthermore, a color filter other than the color filter 13′ shown in FIG. 11 may be used.

The second embodiment is explained with reference to FIGS. 12 to 14. The second embodiment differs from the first embodiment in that a single color-transform signal is generated in each pixel, other constructions are the same as those of the first embodiment.

FIG. 12 is a block diagram of a digital camera according to the second embodiment.

As in the first embodiment, one frame worth of image-pixel signals are read from the CCD 14 and are transmitted to a color-transform processor 20′. In the color-transform processor 20′, as explained below, missing color signals are interpolated by pixels next to a target pixel, and a single color-transform signal is generated in each pixel on the basis of the original color signal and the temporarily interpolated color signals. The generated color-transform signal in each pixel is transmitted to a color-interpolation processor 24′.

In the color-interpolation processor 24′, the color-transform signal Rc, Gc, or Bc in each pixel is temporarily stored in a memory (not shown), and is subjected to a color-interpolation process. Thus, three color-transform signals Rc, Gc, and Bc are generated in each pixel.

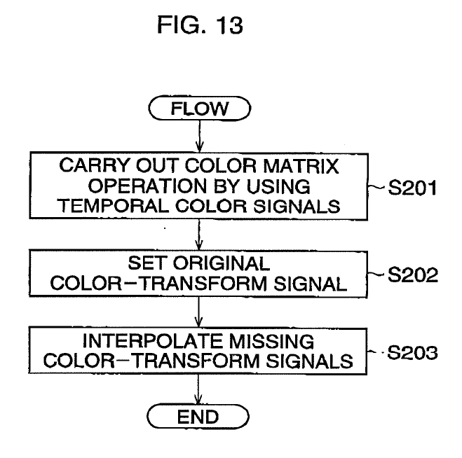

FIG. 13 is a flowchart of a series of image-signal processes used to generate the color-transform signals. The color-transform process and the color interpolation process are explained below in detail.

In the color-transform processor 20′, a color signal in each pixel is subjected to a color-transform process to adjust color-balance (S201). At this time, missing color signals in each pixel are temporarily interpolated using color signals generated over neighboring pixels. Then, a matrix operation is carried out on the three color signals in each pixel to obtain a single color-transform signal. Consequently, color transform signals corresponding to color elements “Y” and “C” are generated as a color-transform signal of “G”, and the color-transform signal Rc, Gc, or Bc is generated in each pixel.

For example, in the case of a pixel which is opposite color element “R”, an average of four color signals “Y” and “C” generated over four pixels, adjacent to a target pixel in the horizontal and vertical directions, is calculated and is defined as a temporary color signal. On the other hand, a missing color signal “B” is interpolated by calculating an average of four color signals “B” over four pixels, which are next to the target pixel in diagonal directions so that a temporary color signal “B′” is generated. Then, the original color signal “Rc” and the interpolated temporary color signals “Gc” and “Bc” in each pixel is multiplied by matrix coefficients (color-transform coefficients), which are based on a color space.

In the case of the pixel P₁₃, a color-transform signal Rc13 is calculated using the following formula.

$$Rc 13 = ( \begin{matrix}1.09 & 0.23 & - 0.36 & 0.04\end{matrix} ) ( \begin{matrix}R 13 \\ {Y}^{′} 13 \\ {C}^{′} 13 \\ {B}^{′} 13\end{matrix} ) \\ ( \begin{matrix}{Y}^{′} 13 = ( Y 12 + Y 14 ) / 2 \\ {C}^{′} 13 = ( C 8 + C 18 ) / 2 \\ {B}^{′} 13 = ( B 7 + B 9 + B 17 + B 19 ) / 4\end{matrix} ) \qquad ( 10 )$$

Herein, the value of each coefficient in the 1×4 matrix shown in the formula (10) is based on the sRGB color space.

On the other hand, in the case of a pixel which is opposite a color element “Y” or “C”, the proximity interpolation process is carried out using pixels opposite “R” and “B” color elements, which are next to a target pixel in the horizontal and vertical directions. Thus, temporary color signals “R′” and “B′” are generated. Also, the proximity interpolation process is carried out using pixels opposite “Y” or “C” color element, which are next to a target pixel in the diagonal directions. Thus, temporary color signals “C′” or “Y′” are generated. Then, a matrix operation is carried out on the original color signal the generated temporary color signals. For example, in the case of the pixel P₁₄ and P₁₈, color-transform signals Gc14 and Gc18 are obtained using the following formulae.

$$\begin{matrix}Gc 14 = ( \begin{matrix}- 0.61 & 1.17 & 0.78 & - 0.33\end{matrix} ) ( \begin{matrix}{R}^{′} 14 \\ Y 14 \\ {C}^{′} 14 \\ {B}^{′} 14\end{matrix} ) \\ ( \begin{matrix}{R}^{′} 14 = ( R 13 + R 15 ) / 2 \\ {C}^{′} 14 = ( C 8 + C 10 + C 18 + C 20 ) / 4 \\ {B}^{′} 14 = ( B 9 + B 19 ) / 2\end{matrix} ) & ( 11 ) \\ Gc 18 = ( \begin{matrix}- 0.61 & 1.17 & 0.78 & - 0.33\end{matrix} ) ( \begin{matrix}{R}^{′} 18 \\ {Y}^{′} 18 \\ C 18 \\ {B}^{′} 18\end{matrix} ) \\ ( \begin{matrix}{R}^{′} 18 = ( R 13 + R 23 ) / 2 \\ {Y}^{′} 18 = ( Y 12 + Y 14 + Y 22 + Y 24 ) / 4 \\ {B}^{′} 18 = ( B 17 + B 19 ) / 2\end{matrix} ) & ( 12 )\end{matrix}$$

Furthermore, in the case of a pixel which is opposite a color element “B”, the proximity interpolation process is carried out using pixels opposite “Y” and “C” color elements, which are next to a target pixel in the horizontal and vertical directions. Thus, temporary color signals “C” and “Y′” are generated. Also, the proximity interpolation process is carried out using pixels opposite “R” color element, which are next to a target pixel in the diagonal directions. Thus, temporary color signals “R′” is generated. Then, a matrix operation is carried out on the color signal “B” and the generated temporary color signals “R′”, “C′” and “Y′”. For example, in the case of the pixel P₁₉, a color-transform signal Bc19 is obtained using the following formula.

$$Bc 19 = ( \begin{matrix}0.11 & - 0.21 & 0.21 & 1.32\end{matrix} ) ( \begin{matrix}{R}^{′} 19 \\ {Y}^{′} 19 \\ {C}^{′} 19 \\ B 19\end{matrix} ) \\ ( \begin{matrix}{R}^{′} 19 = ( R 13 + R 15 + R 23 + R 25 ) / 4 \\ {Y}^{′} 19 = ( Y 14 + Y 24 ) / 2 \\ {C}^{′} 19 = ( C 18 + C 20 ) / 2\end{matrix} ) \qquad ( 13 )$$

The matrixes used in the formulae (11) to (13) are used in a color-transform process on a pixel of corresponding color element.

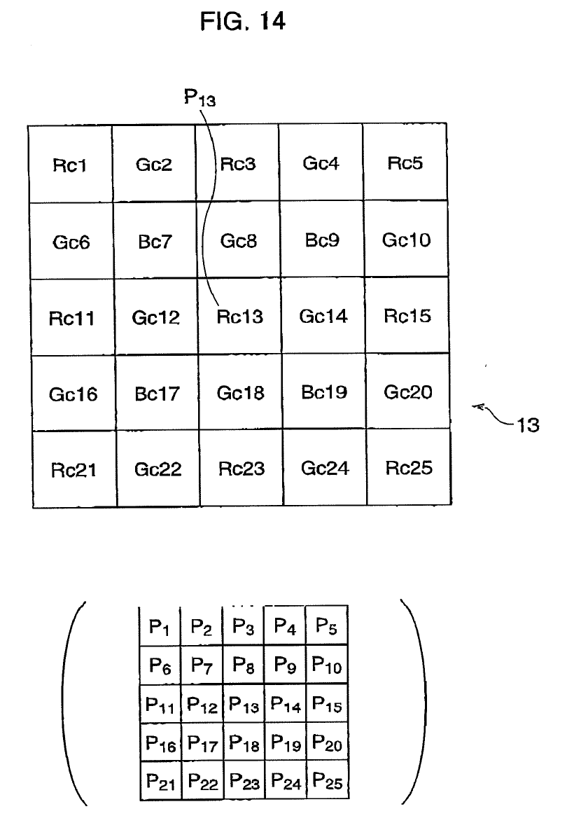

FIG. 14 illustrates color-transform signals corresponding to 5×5 pixel array. One of three color-transform signals “Rc, Gc, and Bc” is generated in each pixel. For example, the pixel P₁₃ has only one color-transform signal Rc13.

In the color-interpolation processor 24, similarly to the first embodiment, the correlation interpolation process is carried out on the color-transform signal such that the three color-transform signals Rs, Gs, and Bs are generated in each pixel.

In this manner, in the second embodiment, color signals read from the CCD 14 are subjected to the color-transform process in the color-transform processor 20′ so that a single color-transform signal is generated in each pixel. Then, color-transform signals corresponding to R, G, and B are generated by the correlation interpolation process. In the color-transform process, missing color signals are temporarily, interpolated, and the original color signal and the interpolated color signals are multiplied by the matrix coefficients based on the sRGB color space.

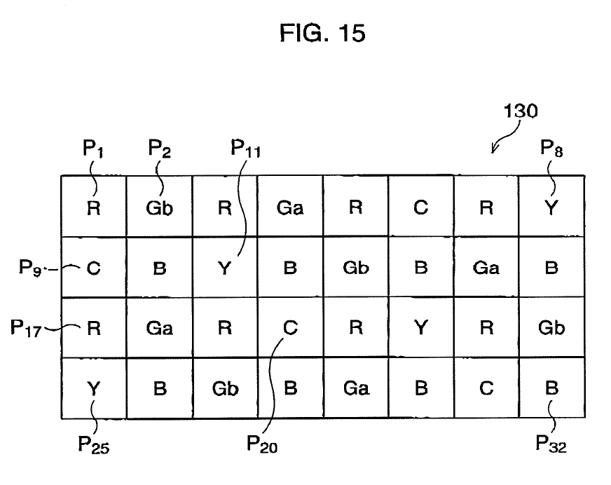

The third embodiment is explained below with reference to FIGS. 15 to 19. The third embodiment differs from the second embodiment in that a color filter array is composed of six color elements. Other constructions are substantially the same as those of the second embodiment, i.e., a single color-transform signal is generated in each pixel.

FIG. 15 is a color filter array used in a digital camera according to the third embodiment.

The color filter array 130 is a mosaic color filter array composed of six color elements, specifically, color elements R and B, and four color elements C, Ga, Gb, and Y, which correspond to the luminosity factor, are arrayed. In FIG. 15, a 4×8 color filter array opposite the 4×8 pixel array is shown. The color elements C, Ga, Gb, and Y are arrayed alternately in diagonal directions of the pixel array. The color elements C and Gb are arrayed alternately in one diagonal direction, whereas the color elements Y and Ga are arrayed alternately in the other diagonal direction. The color elements C, Ga, Gb, and Y are next to color elements R and B in horizontal and vertical directions, and the color elements R and B are arrayed alternately in diagonal directions.

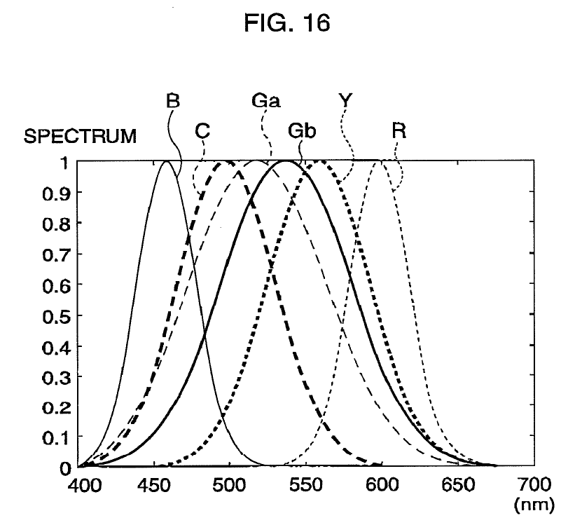

FIG. 16 illustrates spectrum transmittance characteristics of the color filter 130. As shown in FIG. 16, the color elements Ga and Gb have peaks between the peaks of the color elements C and Y. The spectral distributions of the color elements C, Ga, Gb, and Y are defined such that the peaks of the distributions of the color elements C, Ga, Gb, and Y are spaced from each other at substantially equal intervals.

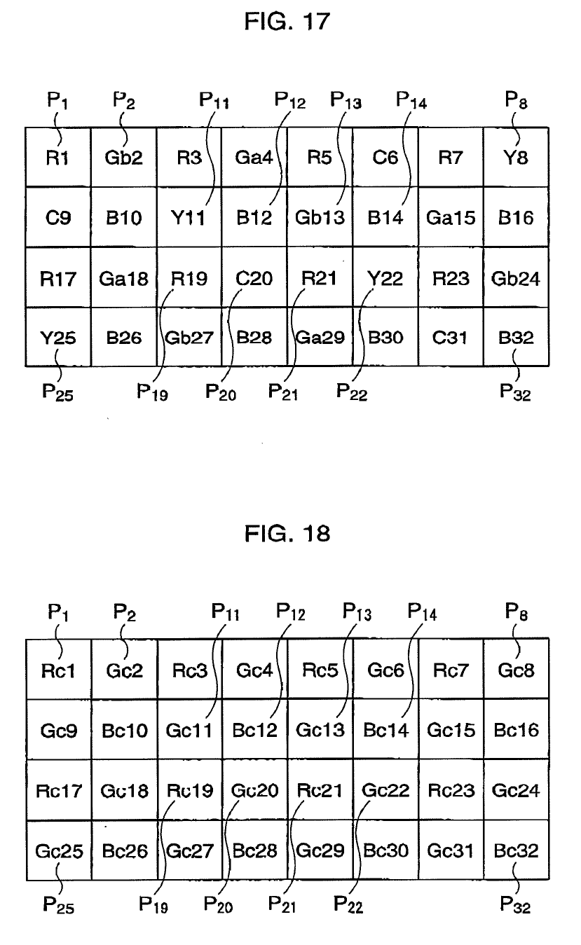

FIG. 17 illustrates color signals generated in the 4×8 pixel array. Similarly to the second embodiment, temporary color signals are generated in each pixel by an interpolation process using color signals of neighboring pixels. Then, a matrix operation using a 1×6 color matrix is carried out. Consequently, one color-transform signal “Rc”, “Gc”, or “Bc”, which corresponds to an opposing color element, is generated in each pixel.

FIG. 18 illustrates color-transform signals in the 4×8 pixel array. For example, the color-transform signal Gc11 of the pixel P₁₁ is obtained using the following formula.

$$\begin{matrix}Gc 11 = ( \begin{matrix}- 0.47 & - 0.31 . & 1.01 & \begin{matrix}1.44 & 0.05 & - 0.72\end{matrix}\end{matrix} ) ( \begin{matrix}{R}^{′} 11 \\ Y 11 \\ {Gb}^{′} 11 \\ {Ga}^{′} 11 \\ {C}^{′} 11 \\ {B}^{′} 11\end{matrix} ) & ( 14 ) \\ ( \begin{matrix}{R}^{′} 11 = ( R 3 + R 19 ) / 2 \\ {Gb}^{′} 11 = Gb 2 \\ {Ga}^{′} 11 = ( Ga 4 + Ga 18 ) / 2 \\ {C}^{′} 11 = C 20 \\ {B}^{′} 11 = ( B 10 + B 12 ) / 2\end{matrix} ) & \end{matrix}$$

As for the color elements C and Gb, only one pixel is next to the pixel P₁₁ (see the pixel P₂ and P₂₀ in FIG. 15), which are different from the pixels opposite the color elements R, B, and Ga. Therefore, the color signals (Gb2 and C20) of the pixel P₂ and P₂₀ are herein directly used, as shown in the above formula.

Likewise, color-transform signals of the pixels P₁₂, P₁₃, P₁₄, P₁₉, P₂₀, P₂₁, and P₂₂ are obtained using the following formulae.

$$\begin{matrix}Bc 12 = ( \begin{matrix}0.03 & - 0.08 & - 0.04 & \begin{matrix}- 0.09 & 0.02 & 1.16\end{matrix}\end{matrix} ) ( \begin{matrix}{R}^{′} 12 \\ {Y}^{′} 12 \\ {Gb}^{′} 12 \\ {Ga}^{′} 12 \\ {C}^{′} 12 \\ B12\end{matrix} ) \\ ( \begin{matrix}{R}^{′} 12 = ( R 3 + R 5 + R 19 + R 21 ) / 4 \\ {Y}^{′} 12 = Y 11 \\ {Gb}^{′} 12 = Gb 13 \\ {Ga}^{′} 12 = Ga 4 \\ {C}^{′} 12 = C 20\end{matrix} ) & ( 15 ) \\ Gc 13 = ( \begin{matrix}- 0.47 & - 0.31 . & 1.01 & \begin{matrix}1.44 & 0.05 & - 0.72\end{matrix}\end{matrix} ) ( \begin{matrix}{R}^{′} 13 \\ {Y}^{′} 13 \\ Gb 13 \\ {Ga}^{′} 13 \\ {C}^{′} 13 \\ {B}^{′} 13\end{matrix} ) \\ ( \begin{matrix}{R}^{′} 13 = ( R 5 + R 21 ) / 2 \\ {Y}^{′} 13 = Y 22 \\ {Ga}^{′} 13 = Ga 4 \\ {C}^{′} 13 = ( C 6 + C 20 ) / 2 \\ {B}^{′} 13 = ( B 12 + B 14 ) / 2\end{matrix} ) & ( 16 ) \\ Bc 14 = ( \begin{matrix}0.03 & - 0.08 & - 0.04 & \begin{matrix}- 0.09 & 0.02 & 1.16\end{matrix}\end{matrix} ) ( \begin{matrix}{R}^{′} 14 \\ {Y}^{′} 14 \\ {Gb}^{′} 14 \\ {Ga}^{′} 14 \\ {C}^{′} 14 \\ B 14\end{matrix} ) \\ ( \begin{matrix}{R}^{′} 14 = ( R 5 + R 7 + R 21 + R 23 ) / 4 \\ {Y}^{′} 14 = Y 22 \\ {Gb}^{′} 14 = Gb 13 \\ {Ga}^{′} 14 = Ga 15 \\ {C}^{′} 12 = C 6\end{matrix} ) & ( 17 ) \\ Rc 19 = ( \begin{matrix}1.20 & 0.56 & - 0.12 & \begin{matrix}- 0.32 & - 0.08 & 0.24\end{matrix}\end{matrix} ) ( \begin{matrix}R 19 \\ {Y}^{′} 19 \\ {Gb}^{′} 19 \\ {Ga}^{′} 19 \\ C 19 \\ {B}^{′} 19\end{matrix} ) \\ ( \begin{matrix}{R}^{′} 19 = Y 11 \\ {Gb}^{′} 19 = Gb 27 \\ {Ga}^{′} 19 = Ga 18 \\ {C}^{′} 19 = C 20 \\ {B}^{′} 19 = ( B 10 + B 12 + B 26 + B 28 ) / 4\end{matrix} ) & ( 18 ) \\ Gc 20 = ( \begin{matrix}- 0.47 & - 0.31 . & 1.01 & \begin{matrix}1.44 & 0.05 & - 0.72\end{matrix}\end{matrix} ) ( \begin{matrix}{R}^{′} 20 \\ {Y}^{′} 20 \\ {Gb}^{′} 20 \\ {Ga}^{′} 20 \\ C 20 \\ {B}^{′} 20\end{matrix} ) \\ ( \begin{matrix}{R}^{′} 20 = ( R 19 + R 21 ) / 2 \\ {Y}^{′} 20 = Y 11 \\ {Gb}^{′} 20 = ( Gb 13 + Gb 27 ) / 2 \\ {Ga}^{′} 20 = Ga 29 \\ {B}^{′} 20 = ( B 12 + B 28 ) / 2\end{matrix} ) & ( 19 ) \\ Rc 21 = ( \begin{matrix} 1.20 & 0.56 & - 0.12 & \begin{matrix}- 0.32 & - 0.08 & 0.24\end{matrix}\end{matrix} ) ( \begin{matrix}R 21 \\ {Y}^{′} 21 \\ {Gb}^{′} 21 \\ {Ga}^{′} 21 \\ {C}^{′} 21 \\ {B}^{′} 21\end{matrix} ) \\ ( \begin{matrix}{Y}^{′} 21 = Y 22 \\ {Gb}^{′} 21 = Gb 13 \\ {Ga}^{′} 21 = Ga 29 \\ {C}^{′} 21 = C 20 \\ {B}^{′} 21 = ( B 12 + B 14 + B 28 + B 30 ) / 4\end{matrix} ) & ( 20 ) \\ Gc 22 = ( \begin{matrix}- 0.47 & - 0.31 . & 1.01 & \begin{matrix}1.44 & 0.05 & - 0.72\end{matrix}\end{matrix} ) ( \begin{matrix}{R}^{′} 22 \\ Y22 \\ {Gb}^{′} 22 \\ {Ga}^{′} 22 \\ {C}^{′} 22 \\ {B}^{′} 22\end{matrix} ) \\ ( \begin{matrix}{R}^{′} 22 = ( R 21 + R 23 ) / 2 \\ {Gb}^{′} 22 = Gb 13 \\ {Ga}^{′} 22 = ( Ga 15 + Ga 29 ) / 2 \\ {C}^{′} 22 = C 31 \\ {B}^{′} 22 = ( B 14 + B 30 ) / 2\end{matrix} ) & ( 21 )\end{matrix}$$

After the color-transform signal is generated in each pixel, the correlation interpolation process is carried out. Thus, three color-transform signals Rs, Gs, and Bs are generated in each pixel. Also, the proximity interpolation process may be used instead of the correlation interpolation process.

In this a manner, in the third embodiment, the four color elements “C, Ga, Gb, and Y” based on the luminosity factor are arrayed alternately in diagonal directions. Since many color elements corresponding to “G” are included in the color filter array, a high-resolution image is obtained. Also, since the four color elements are arrayed in diagonal directions, the degradation of resolution in the color-signal interpolation and color-transform processes is prevented. On the other hand, in each pixel, a color-transform signal having the strongest correlation with an opposing color element is generated. Namely, in the case of the color elements C, Ca, Cb, and Y, the color-transform signal of is generated for “G”. Thus, the occurrence of false color is prevented.

The color-transform process may calculate three color-transform signals in each pixel, in a manner similar to that of the first embodiment. In this case, a matrix operation according to the following formula is carried out.

$$( \begin{matrix}Rc \\ Gc \\ Bc\end{matrix} ) = ( \begin{matrix}1.20 & 0.56 & - 0.12 & - 0.32 & - 0.08 & 0.24 \\ - 0.47 & - 0.31 & 1.01 & 1.44 & 0.55 & - 0.72 \\ 0.03 & - 0.08 & - 0.04 & - 0.09 & 0.02 & 1.26\end{matrix} ) ( \begin{matrix}{R}_{0} \\ {Y}_{0} \\ {Gb}_{0} \\ {Ga}_{0} \\ {C}_{0} \\ {B}_{0}\end{matrix} ) \qquad ( 22 )$$

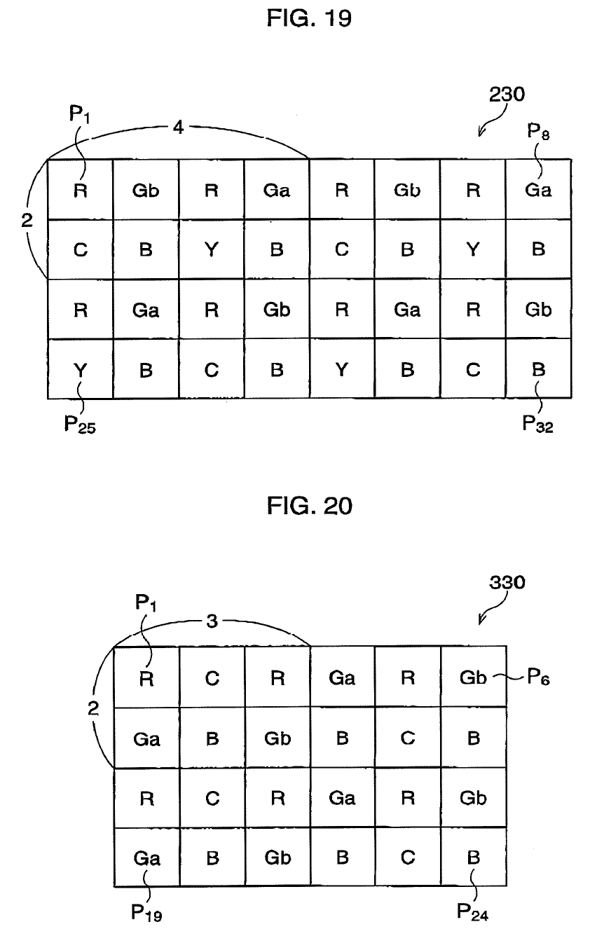

FIG. 19 illustrates a color filter array that is a variation of the third embodiment. In the color filter 230, the color elements “C” and “Gb” are arrayed in a diagonal direction, however, the order of the array is reversed (see FIGS. 15 and 19). Herein, 2×4 color elements are repeated in the color filer 230.

The fourth embodiment is explained with reference to FIGS. 20 to 22. The fourth embodiment differs from the first and second embodiments in that five color elements are used. Other constructions are substantially the same as those of the second embodiment.

FIG. 20 is a color filter array used in a digital camera according to the fourth embodiment. The color filer array 330 is a mosaic filter composed of five color elements R, Gb, Ga, C, and B. The color elements Ga, Gb, and C, based on luminosity, are arrayed in diagonal directions. In the color filter 330, the 2×3 color element array is repeated.

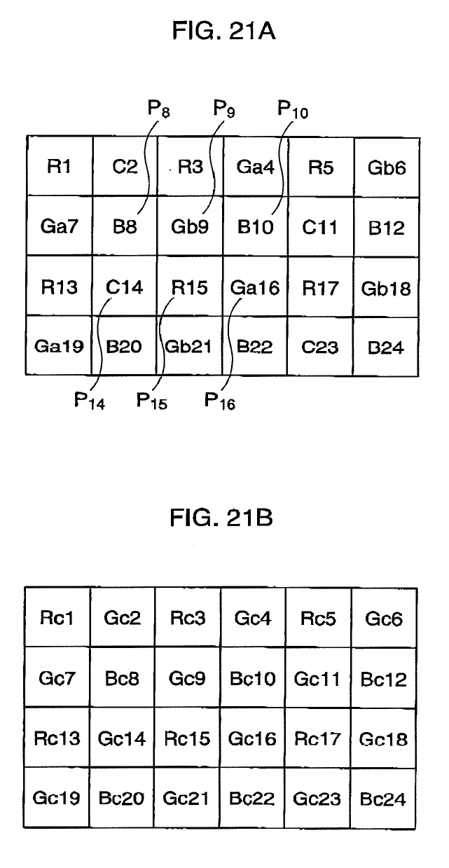

FIGS. 21A and 21B illustrate color signals and color-transform signals in a 4×6 pixel array. In a manner similar to that of the second embodiment, temporary color signals are generated in each pixel. Then, a matrix operation using a 1×5 color matrix is carried out. Thus, one color-transform signal Rc, Gc, or Bc is generated in each pixel (see FIG. 21B). Furthermore, missing color-transform signals are interpolated such that three color-transform signals Rs, Gs, and Bs are generated in each pixel.

For example, color-transform signals Bc8, Gc9, Bc10, Gc14, Rc15, Gc16 for the pixels P₈, P₉, P₁₀, P₁₄, P₁₅, and P₁₆, are calculated using the following formulae.

$$\begin{matrix}Bc 8 = ( \begin{matrix}0.03 & - 0.05 & - 0.23 & \begin{matrix}0.03 & 1.22\end{matrix}\end{matrix} ) ( \begin{matrix}{R}^{′} 8 \\ {Gb}^{′} 8 \\ {Ga}^{′} 8 \\ {C}^{′} 8 \\ B 8\end{matrix} ) \\ ( \begin{matrix}{R}^{′} 8 = ( R 1 + R 3 + R 13 + R 15 ) / 4 \\ {Gb}^{′} 8 = Gb 9 \\ {Ga}^{′} 8 = Ga 7 \\ {C}^{′} 8 = ( C 2 + C 14 ) / 2\end{matrix} ) & ( 23 ) \\ Gc 9 - ( \begin{matrix}- 0.47 & 0.28 & 1.24 & \begin{matrix}0.65 & - 0.77\end{matrix}\end{matrix} ) ( \begin{matrix}{R}^{′} 9 \\ Gb 9 \\ {Ga}^{′} 9 \\ {C}^{′} 9 \\ {B}^{′} 9\end{matrix} ) \\ ( \begin{matrix}{R}^{′} 9 = ( R 3 + R 15 ) / 2 \\ {Ga}^{′} 9 = ( Ga 4 + Ga 16 ) / 2 \\ {C}^{′} 9 = ( C 2 + C 14 ) / 2 \\ {B}^{′} 9 = ( B 8 + B 10 ) / 2\end{matrix} ) & ( 24 ) \\ Bc 10 = ( \begin{matrix}0.03 & - 0.05 & - 0.23 & \begin{matrix}0.03 & 1.22\end{matrix}\end{matrix} ) ( \begin{matrix}{R}^{′} 10 \\ {Gb}^{′} 10 \\ {Ga}^{′} 10 \\ {C}^{′} 10 \\ B 10\end{matrix} ) \\ ( \begin{matrix}{R}^{′} 10 = ( R 3 + R 5 + R 15 + R 17 ) / 4 \\ {Gb}^{′} 10 = Gb 9 \\ {Ga}^{′} 10 = ( Ga 4 + Ga 16 ) / 2 \\ {C}^{′} 10 = C 11\end{matrix} ) & ( 25 ) \\ Gc 14 = ( \begin{matrix}- 0.47 & 0.28 & 1.24 & \begin{matrix}0.65 & - 0.77\end{matrix}\end{matrix} ) ( \begin{matrix}{R }^{′} 14 \\ {Gb}^{′} 14 \\ {Ga}^{′} 14 \\ C 14 \\ {B}^{′} 14\end{matrix} ) \\ ( \begin{matrix}{R}^{′} 14 = ( R 13 + R 15 ) / 2 \\ {Gb}^{′} 14 = ( Gb 9 + Gb 21 ) / 2 \\ {Ga}^{′} 14 = ( Ga 7 + Ga 19 ) / 2 \\ {B}^{′} 14 = ( B 8 + B 20 ) / 2\end{matrix} ) & ( 26 ) \\ Rc 15 = ( \begin{matrix}0.96 & 0.22 & - 0.20 & \begin{matrix}- 0.11 & 0.14\end{matrix}\end{matrix} ) ( \begin{matrix}R 15 \\ {Gb}^{′} 15 \\ {Ga}^{′} 15 \\ {C}^{′} 15 \\ {B}^{′} 15\end{matrix} ) \\ ( \begin{matrix}{Gb}^{′} 15 = ( Gb 9 + Gb 21 ) / 2 \\ {Ga}^{′} 15 = Ga 16 \\ {C}^{′} 15 = C 14 \\ {B}^{′} 15 = ( B 8 + B 10 + B 20 + B 22 ) / 4\end{matrix} ) & ( 27 ) \\ Gc 16 = ( \begin{matrix}- 0.47 & 0.28 & 1.24 & \begin{matrix}0.65 & - 0.77\end{matrix}\end{matrix} ) ( \begin{matrix}{R}^{′} 16 \\ {Gb}^{′} 16 \\ Ga 16 \\ {C}^{′} 16 \\ {B}^{′} 16\end{matrix} ) \\ ( \begin{matrix}{R}^{′} 14 = ( R 15 + R 17 ) / 2 \\ {Gb}^{′} 14 = ( Gb 9 + Gb 21 ) / 2 \\ {C}^{′} 16 = ( C 11 + C 23 ) / 2 \\ {B}^{′} 16 = ( B 10 + B 22 ) / 2\end{matrix} ) & ( 28 )\end{matrix}$$

The color-transform process may calculate three color-transform signals in each pixel, similarly to the first embodiment. In this case, the matrix operation shown in the following formula is carried out.

$$( \begin{matrix}Rc \\ Gc \\ Bc\end{matrix} ) = ( \begin{matrix}0.96 & 0.22 & - 0.20 & - 0.11 & 0.14 \\ - 0.47 & 0.28 & 1.24 & 0.65 & - 0.77 \\ 0.03 & - 0.05 & - 0.23 & 0.03 & 1.12\end{matrix} ) ( \begin{matrix}{R}_{0} \\ {Gb}_{0} \\ {Ga}_{0} \\ {C}_{0} \\ {B}_{0}\end{matrix} ) \qquad ( 29 )$$

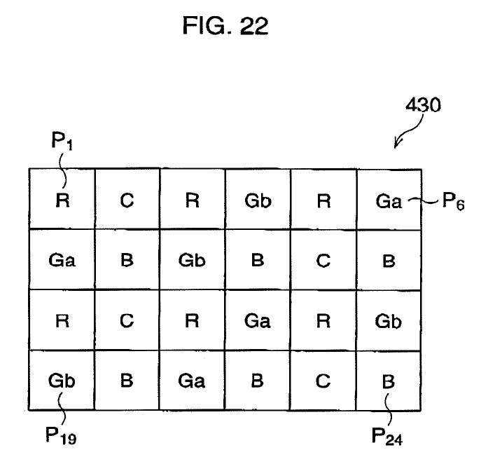

FIG. 22 illustrates a color filter array that is a variation of the color filter according to the fourth embodiment. In the color filter array 430, the color elements “C” and “Gb” are arrayed in a diagonal direction, however, the order of the array is reversed (see FIGS. 20 and 22).

As for a color interpolation process, an interpolation process other than the proximity interpolation process (said linear interpolation process), and one other than the correlation interpolation process, may optionally be utilized. In this case, neighboring pixels or adjacent pixels may be used in the interpolation process for generating temporal color signals such that the occurrence of false color is prevented. On the other hand, surrounding pixels may be used with neighboring pixels such so as to obtain a high-resolution image.

As for the color space, one other than the sRGB color space, such as a YUV color space, La*b* color space, Lu*v* color space, X-Y-Z color system, etc., may be used. In addition, a complementary color filter array may be used rather than the R, G, and B color filter array.

The series of interpolation processes and the color-transform process may be carried out through software. Furthermore, the image-pixel signal process above may be performed in an imaging device other than the digital camera, such as a cellular phone, or an endoscope system, etc.

The present disclosure relates to subject matter contained in Japanese Patent Application No. 2008-141571 (filed on May 29, 2008), which is expressly incorporated herein by reference, in its entirety.

1. An imaging device comprising:
an image sensor with a mosaic color filter array comprising at least four color elements, the color elements arrayed such that each color element opposes a pixel in said image sensor;
a color-transform processor that generates at least one color-transform signal in each pixel while interpolating missing color signals on the basis of color signals from surrounding pixels; and
a color-interpolation processor that generates at least one color-transform signal that does not correspond to an opposing color element in each pixel, on the basis of color-transform signals that are generated over surrounding pixels and that correspond to opposing color elements of the surrounding pixels,
said color filter array being configured such that at least two color elements that are correlated with respect to spectrum transmittance characteristics are arrayed alternately in a diagonal direction of the pixel array.

2. The imaging device of claim 1, wherein said color filter array comprises at least five color elements, at least three of which are correlated with respect to the spectrum transmittance characteristics.

3. The imaging device of claim 1, wherein said color filter array comprises six color elements, four of which are correlated with respect to the spectrum transmittance characteristics.

4. The imaging device of claim 3, wherein color elements “Y and Ga” or “C and Gb” are arrayed alternately in one diagonal direction, and color elements “Ga, Gb, Y, and C” are arrayed repeatedly in another diagonal direction.

5. The imaging device of claim 3, wherein color elements “Y and Ga” are arrayed alternately in one diagonal direction, and color elements “Ga and C” or “Gb and Y” are arrayed alternately in another diagonal direction.

6. The imaging device of claim 1, wherein said color filter array comprises five color elements, three of which are correlated with respect to the spectrum transmittance characteristics.

7. The imaging device of claim 6, wherein color elements “C, Gb, and Ga” are arrayed repeatedly in diagonal directions.

8. The imaging device of claim 6, wherein color elements “Gb, C, and Gb” are arrayed repeatedly in one diagonal direction.

9. The imaging device of claim 1, wherein said color-transform processor generates at least one color-transform signal that has the strongest correlation within the spectrum transmittance characteristics of an opposing color element.

10. The imaging device of claim 1, wherein said at least two color elements are ones corresponding to a color “G” or the spectral distributions of the luminosity.

11. The imaging device of claim 1, wherein said color-transform processor interpolates missing color signal in each pixel by using color signals generated over adjacent pixels, and generates three color-transform signals by carrying out a color-transform process on the three color signals, said color-interpolation processor replacing color-transform signals based on the interpolated color signals with interpolation color-transform signals, the interpolation color-transform signals being generated by an interpolation process based on color-transform signals generated over surrounding pixels that correspond to opposing color elements of the surrounding pixels.

12. The imaging device of claim 11, wherein said color-transform processor interpolates missing color signals on the basis of color signals generated over neighboring pixels.

13. The imaging device of claim 1, wherein said color-transform processor interpolates missing color signals on the basis of color signals of adjacent pixels, and generates a single color-transform signal by multiplying the original color signal and the interpolated color signals by color-transform coefficients.

14. The imaging device of claim 13, wherein said color-transform processor interpolates missing color signals on the basis of color signals generated over neighboring pixels.

15. The imaging device of claim 11, wherein said color-interpolation processor carries out an interpolation process on the basis of color-transform signals generated over adjacent pixels that have relatively strong correlation with a target pixel.

16. The imaging device of claim 15, wherein said color-interpolation processor calculates color difference signals of a neighboring pixel that has relatively strong correlation with a target pixel on the basis of color-transform signal generates the neighboring pixel, and generates the interpolation color-transform signals from the color-transform signal of the target pixel and the calculated color difference signals.

17. The imaging device of claim 1, wherein said color-transform processor interpolates color signals by carrying out an interpolation process based on color signals from neighboring pixels.
